(19) United States
(12) Patent Application Publication
(10) Pub. No.: US 2026/0023368 A1
(43) Pub. Date: Jan. 22, 2026

(54) FLEXIBLE JOB-SHOP PRODUCTION SCHEDULING METHOD AND APPARATUS

(71) Applicant: BOE Technology Group Co., Ltd., Beijing (CN)

(72) Inventors: Jifang HAO, Beijing (CN); Zhuoshi YANG, Beijing (CN)

(21) Appl. No.: 18/993,510

(22) PCT Filed: Jul. 5, 2023
(86) PCT No.: PCT/CN2023/105813

§ 371 Date: Jan. 10, 2025

(30) Foreign Application Priority Data
Jul. 29, 2022 (CN) 202210906147.1

(51) Int. Cl. G05B 19/418

(52) U.S. Cl. CPC G05B 19/41865; G05B 2219/32252

(57) ABSTRACT

A flexible job-shop production scheduling method and apparatus, an electronic device, and a computer-readable storage medium. The method includes: generating an initialized population according to information of workpieces to be produced, the population including a plurality of production scheduling schemes, and each production scheduling scheme representing a scheduling sequence of said workpieces; and performing iterative update on the population on the basis of a preset target iterative algorithm, and determining a target production scheduling scheme according to the iterative process.

This application is a US national stage of international application No. PCT/CN2023/105813, filed on Jul. 5, 2023, which claims priority to Chinese Patent Application No. 202210906147.1, filed on Jul. 29, 2022, the disclosures of which are incorporated herein by reference in their entireties.

### TECHNICAL FIELD

The present disclosure relates to the field of industrial manufacturing technologies, in particular to a production scheduling method and apparatus for a flexible job shop, an electronic device and a computer-readable storage medium.

### BACKGROUND OF THE INVENTION

One of the most difficult problems in the field of industrial manufacturing process planning and management is a job-shop scheduling problem (JSP). In this problem, a group of machines needs to process a group of workpieces, and each workpiece is formed through a series of processes with sequential constraints. Each process requires only one machine which is always available and can process one operation at a time without any interruption. Decision-making content includes how to sequence the processes on a machine to optimize a given performance index. A typical performance index for the JSP is production makespan, i.e., time required for completion of all jobs.

A flexible job-shop scheduling problem (FJSP) is an extension of a classic JSP. Each process in this problem allows processing on any machine in a group of available machines. FJSP is more difficult than traditional JSP because it introduces another decision-making content in addition to sequence, that is, a job path. determining the job path means deciding which machine to be used to process it for each process.

### SUMMARY OF THE INVENTION

The present disclosure provides a production scheduling method and apparatus for a flexible job shop, an electronic device and a computer-readable storage medium.

According to a first aspect of the present disclosure, the present disclosure provides a production scheduling method for a flexible job shop. The production scheduling method for the flexible job shop includes:
generating an initialized population according to information on to-be-produced workpieces, where the population includes a plurality of production scheduling schemes, each of the plurality of production scheduling schemes represents a production scheduling sequence of the to-be-produced workpieces; and
performing iterative updating on the population based on a preset target iterative algorithm, and determining a target production scheduling scheme according to an iteration process.

In some embodiments, before performing the iterative updating on the population based on the preset target iterative algorithm, the production scheduling method further includes: acquiring an adaptive value corresponding to the production scheduling scheme for each of the plurality of production scheduling schemes in the population, where the adaptive value represents a production makespan corresponding to the production scheduling scheme; and
the performing the iterative updating on the population based on the preset target iterative algorithm and determining the target production scheduling scheme according to the iteration process includes:
performing iterative updating on the population according to the adaptive value based on the preset target iterative algorithm; and
determining the target production scheduling scheme according to an optimal solution obtained in the iteration process.

In some embodiments, after each iterative updating, the production scheduling method further includes:
determining whether a current iteration round exceeds an iteration round threshold;
returning a step of acquiring the adaptive value corresponding to the production scheduling scheme for each of the plurality of production scheduling schemes in the population, in response to the current iteration round not exceeding the iteration round threshold; and
jumping to executing a step of determining the target production scheduling scheme according to the optimal solution obtained in the iteration process, in response to the current iteration round exceeding the iteration round threshold.

In some embodiments, the target iterative algorithm includes a first particle swarm algorithm; the workpiece information includes types of to-be-produced workpieces, a number of each type of workpieces, a total number of processes of each type of workpieces, a number of stage processes corresponding to each production stage, and a batch size of batch production; and the generating the initialized population according to the information on the to-be-produced workpieces includes:
determining type codes of each type of workpieces according to a ratio of the number of each type of workpieces to the batch size, in order to obtain a type code sequence;
performing code extension on each type code in the type code sequence according to the number of production stages of each type of workpieces to obtain a first extended code sequence, where each element in the first extended code sequence represents a corresponding workpiece type and a corresponding production stage, and the number of production stages is a ratio of the total number of processes to the number of stage processes;
adjusting sequence of elements in the first extended code sequence, and generating a plurality of second extended code sequences having different sequences of elements, where each population particle corresponds to one second extended code sequence;
generating a weight code sequence and a velocity list which correspond to the population particle for each population particle in the population, where the weight code sequence includes weight codes that are in one-to-one correspondence to the elements corresponding to the second extended code sequence, and the velocity list includes velocities that are in one-to-one correspondence to the elements corresponding to the second extended code sequence; and
performing code extension on each element in the second extended code sequence corresponding to the population particle according to the number of each type of workpieces and the number of stage processes to obtain a third extended code sequence corresponding to the population particle, where each element in the third extended code sequence represents a workpiece number of one workpiece and a stage process in the corresponding production stage, and the third extended code sequence represents one production scheduling scheme.

In some embodiments, the performing the iterative updating on the population according to the adaptive value based on the target iterative algorithm includes:
determining a current global optimal solution of the population according to an adaptive value corresponding to each population particle, where the current global optimal solution of the population is a current global optimal population particle;
for each population particle, updating a weight code sequence corresponding to the population particle according to a weight code sequence corresponding to the current global optimal solution of the population and the weight code sequence corresponding to the population particle;
adjusting a sequence of corresponding elements in the second extended code sequence corresponding to the population particle according to the updated weight code sequence corresponding to the population particle; and
adjusting a sequence of corresponding elements in the third extended code sequence corresponding to the population particle according to adjusted second extended code sequence corresponding to the population particle to update a corresponding production scheduling scheme.

In some embodiments, the target iterative algorithm includes a genetic algorithm; the workpiece information includes types of to-be-produced workpieces, a number of each type of workpieces, and a batch size of batch production; and the generating the initialized population according to the information on the to-be-produced workpieces includes:
performing chromosome coding according to the types of to-be-produced workpieces to obtain a plurality of type chromosome coding sequences; and
decoding each type chromosome coding sequence according to the number of each type of workpieces to obtain an individual chromosome decoding sequence corresponding to each type chromosome coding sequence, where each element in the individual chromosome decoding sequence represents a workpiece number of each workpiece corresponding to the workpiece type, and each individual chromosome decoding sequence represents one production scheduling scheme.

In some embodiments, the performing the iterative updating on the population according to the adaptive value based on the target iterative algorithm includes:
regenerating the individual chromosome decoding sequence into a corresponding type chromosome coding sequence according to a reverse order of decoding, for each individual chromosome decoding sequence in the population;
performing a genetic operation on the type chromosome coding sequence in the population based on an adaptive value corresponding to each of the plurality of type chromosome coding sequences in the population, so as to update the type chromosome coding sequence in the population; and
decoding each updated type chromosome coding sequence in the population to obtain an individual chromosome decoding sequence corresponding to the each updated type chromosome coding sequence.

In some embodiments, the target iterative algorithm includes a second particle swarm algorithm; the workpiece information includes a number of to-be-produced workpieces, and a number of processes of each workpiece; and the generating the initialized population according to the information on the to-be-produced workpieces includes:
generating a plurality of production scheduling schemes according to the number of to-be-produced workpieces and the number of process of each workpiece, where each production scheduling scheme corresponds to one population particle; and
randomly initializing inertia weight, position and velocity parameters corresponding to each population particle.

In some embodiments, the performing the iterative updating on the population according to the adaptive value based on the target iterative algorithm includes:
dividing a plurality of population particles in the population into a plurality of groups of population particles according to a corresponding sequence of adaptive values from small to large, where each group of population particles includes a master population particle and at least one slave population particle;
determining an in-group optimal solution of each group of population particles according to a corresponding adaptive value of each population particle in each group of population particles, where the in-group optimal solution is a population particle corresponding to a minimum value among adaptive values of all population particles in the group, and a position of the master population particle is a position of a population particle corresponding to the in-group optimal solution;
determining a current global optimal solution of the population according to the adaptive value corresponding to the in-group optimal solution of each group of population particles, the current global optimal solution being an in-group optimal solution corresponding to the minimum adaptive value; and
updating a position and velocity of each population particle in each group of population particles according to the in-group optimal solution and the current global optimal solution of the population, for each group of population particles.

In some embodiments, after the performing the iterative updating on the population according to the adaptive value based on the target iterative algorithm, the method further includes:
determining inert population particles in the population according to a historical velocity and a historical position of each population particle in the population; and
eliminating the inert population particles from the population, and adding a corresponding number of new population particles to the population.

In some embodiments, the determining the inert population particles in the population according to the historical velocity and the historical position of each population particle in the population includes:
determining the population particles to be the inert population particles in response to a variation in a plurality of historical velocities of the population particles being less than a first threshold, and a variation in a plurality of historical positions of the population particles being less than a second threshold.

According to a second aspect of the present disclosure, the present disclosure provides a production scheduling apparatus for a flexible job shop. The production scheduling apparatus for the flexible job shop includes:
an initializing unit, configured to generate an initialized population according to information on to-be-produced workpieces, where the population includes a plurality of production scheduling schemes, and each of the plurality of production scheduling schemes represents a production scheduling sequence of the to-be-produced workpieces; and
an updating iteration unit, configured to perform iterative updating on the population based on a preset target iterative algorithm, and determine a target production scheduling scheme according to an iteration process.

In some embodiments, the production scheduling apparatus further includes an acquiring unit, wherein
the acquiring unit is configured to acquire an adaptive value corresponding to the production scheduling scheme for each of the plurality of production scheduling schemes in the population, where the adaptive value represents a production makespan corresponding to the production scheduling scheme; and
an updating iteration unit includes an updating sub-unit configured to perform iterative updating on the population according to the adaptive value based on the target iterative algorithm; and a target determining sub-unit configured to determine a target production scheduling scheme according to an optimal solution obtained in the iteration process.

According to a third aspect of the present disclosure, the present disclosure provides an electronic device. The electronic device includes:
at least one processor; and
a memory being in communication connection with the at least one processor, wherein
the memory is configured to store one or more computer programs that may be executed by the at least one processor, the one or more computer programs, when being executed by the at least one processor, cause the at least one processor to implement the above-mentioned production scheduling method.

According to a fourth aspect of the present disclosure, the present disclosure provides a computer-readable storage medium which is configured to store a computer program therein, the computer program, when being executed by a processor, implementing the above-mentioned production scheduling method.

### BRIEF DESCRIPTION OF DRAWINGS

The accompanying drawings are used to provide a further understanding of the present disclosure, and constitute a part of the description, and are used to explain the present disclosure together with the embodiments of the present disclosure, without limiting the present disclosure. The above and other features and advantages will become more apparent for those skilled in the art from the detailed exemplary embodiments with reference to the accompanying drawings. In drawings:

FIG. 1 is a schematic flowchart of a production scheduling method for a flexible job shop according to an embodiment of the present disclosure;

FIG. 2 is a schematic flowchart of another production scheduling method for a flexible job shop according to an embodiment of the present disclosure;

FIG. 3 is a schematic flowchart of a specific implementation of S11 in FIG. 2;

FIG. 4 is a schematic flowchart of a specific implementation of S13 in FIG. 2;

FIG. 5 is a schematic flowchart of another specific implementation of S11 in FIG. 2;

FIG. 6 is a schematic flowchart of another specific implementation of S13 in FIG. 2;

FIG. 7 is a schematic flowchart of another specific implementation of S11 in FIG. 2;

FIG. 8 is a schematic flowchart of another specific implementation of S13 in FIG. 2;

FIG. 9 is a schematic diagram of changes in production makespan of a production scheduling scheme in an iterative updating process using a target iterative algorithm according to an embodiment of the present disclosure;

FIG. 10 is a schematic structural diagram of a production scheduling apparatus for a flexible job shop according to an embodiment of the present disclosure;

FIG. 11 is a schematic structural diagram of another production scheduling apparatus for a flexible job shop according to an embodiment of the present disclosure; and

FIG. 12 is a block diagram of an electronic device according to an embodiment of the present disclosure.

### DETAILED DESCRIPTION

In order to enable those skilled in the art to better understand the technical solutions of the present disclosure, the following exemplary embodiments of the present disclosure are illustrated in conjunction with the accompanying drawings, including various details of the embodiments of the present disclosure to facilitate understanding, and these details should be regarded as merely exemplary. Therefore, a person of ordinary skill in the art should be aware that various changes and modifications may be made to the embodiments described herein without deviating from the scope and spirit of the present disclosure. Similarly, for the sake of clarity and conciseness, descriptions of well-known functions and structures may be omitted in the following description.

The embodiments in the present disclosure and the features in the embodiments can be combined with each other if there is no conflict.

The term “and/or” as used herein includes any and all combinations of one or more related listed items.

The terms used herein are for the purpose of describing particular embodiments only and are not intended to limit the present disclosure. As used herein, the singular forms “one” and “the” are also intended to include a plural form, unless the context clearly stated otherwise. It will also be understood that when the term “include/comprise” and/or “made of . . . ” used in the present description means there exists a feature, an integer, a step, an operation, an element and/or a component, but could not preclude existing or adding of one or more other features, integers, steps, operations, elements, components and/or groups thereof. The word “connected” or “coupled” and similar terms are not limited to physical or mechanical connections, and may include electrical connection regardless of a direct connection or an indirect connection.

Unless otherwise defined, all terms (including technical terms and scientific terms) used herein have the same meaning as commonly understood by a person of ordinary skill in the art. It will also be understood that terms such as those defined in commonly used dictionaries shall be construed as having meanings consistent with their meanings in the context of the related technologies and the present disclosure, and will not be construed as having an idealized or excessively formal meaning, unless expressly so qualified herein.

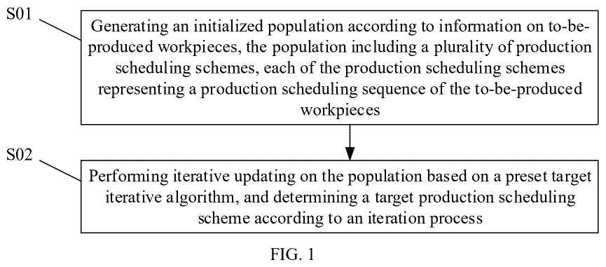

FIG. 1 is a schematic flowchart of a production scheduling method for a flexible job shop according to an embodiment of the present disclosure. As shown in FIG. 1, the production scheduling method includes the following steps S01 to S02.

In S01, an initialized population is generated according to information on to-be-produced workpieces, the population including a plurality of production scheduling schemes, each of the production scheduling schemes representing a production scheduling sequence of the to-be-produced workpieces.

In S02, iterative updating is performed on the population based on a preset target iterative algorithm, and a target production scheduling scheme is determined according to an iteration process.

According to the production scheduling method provided by this embodiment of the present disclosure, a target production scheduling scheme is obtained by iterating and solving an optimal solution for the production scheduling scheme in the population based on the target iterative algorithm. The target production scheduling scheme may be used to guide a factory to formulate a production plan, which may not only increase a utilization rate of a production device, but also effectively complete a machining task of the corresponding workpiece within the shortest time, and maximally satisfy a workpiece production and delivery plan.

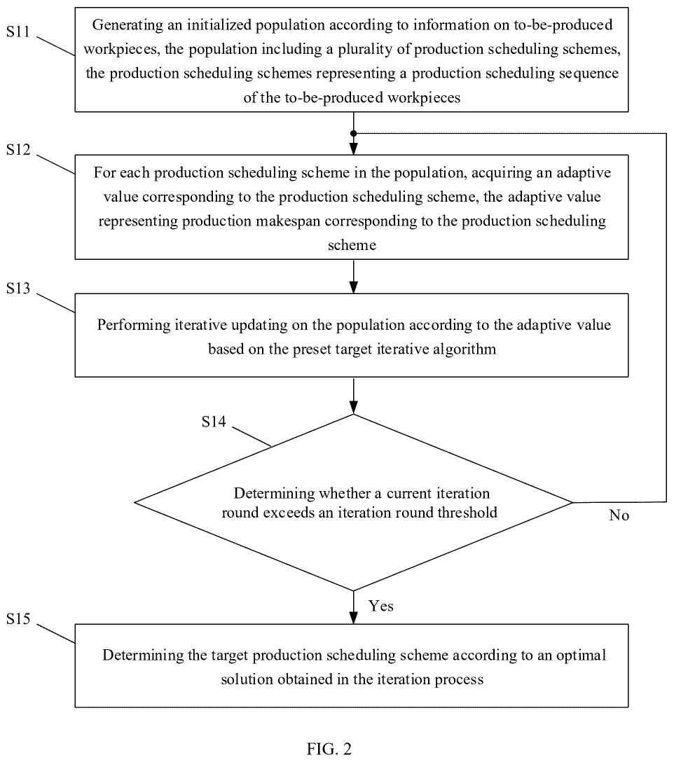

FIG. 2 is a schematic flowchart of another production scheduling method for a flexible job shop according to an embodiment of the present disclosure. As shown in FIG. 2, the production scheduling method includes the following steps.

In S11, an initialized population is generated according to information on to-be-produced workpieces, the population including a plurality of production scheduling schemes, the production scheduling schemes representing a production scheduling sequence of the to-be-produced workpieces.

In S12, for each production scheduling scheme in the population, an adaptive value corresponding to the production scheduling scheme is acquired, the adaptive value representing a production makespan corresponding to the production scheduling scheme.

The production makespan refers to time consumed from the start of production processing to the completion of production when the to-be-produced workpiece is produced and processed by a production device according to a production scheduling scheme.

As shown in FIG. 2, the step of performing the iterative updating on the population based on the preset target iterative algorithm and determining the target production scheduling scheme according to the iteration process may further include the following steps S13 and S15.

In S13, iterative updating is performed on the population according to the adaptive value based on the target iterative algorithm.

In S15, the target production scheduling scheme is determined according to an optimal solution obtained in the iteration process.

In some embodiments, as shown in FIG. 2, after each iterative updating, i.e., after S13, the production scheduling method further includes a step S14.

In S14, whether a current iteration round exceeds an iteration round threshold is determined; if so, this step jumps to perform S15; and if not, this step returns to S12.

In response to the current iteration round not exceeding the iteration round threshold, for the updated population, this step returns to a step of acquiring the adaptive value corresponding to the production scheduling scheme for each production scheduling scheme in the population. In response to the current iteration round exceeding the iteration round threshold, this step jumps to perform the step of determining the target production scheduling scheme based on the optimal solution obtained in the iteration process. The iteration round threshold may be set based on actual needs, for example, the iteration round threshold may be set to 100.

According to the production scheduling method provided by this embodiment of the present disclosure, the iterative updating of the population is performed by acquiring the adaptive value of each production scheduling scheme in the population. The optimal solution in the iteration process is determined based on the adaptive value in the iteration process to determine the optimal target production scheduling scheme in the population. The target production scheduling scheme may be used to guide a factory to formulate a production plan, which may not only increase a utilization rate of the production device, but also effectively complete a machining task of the corresponding workpiece within the shortest time, and maximally satisfy a workpiece production and delivery plan.

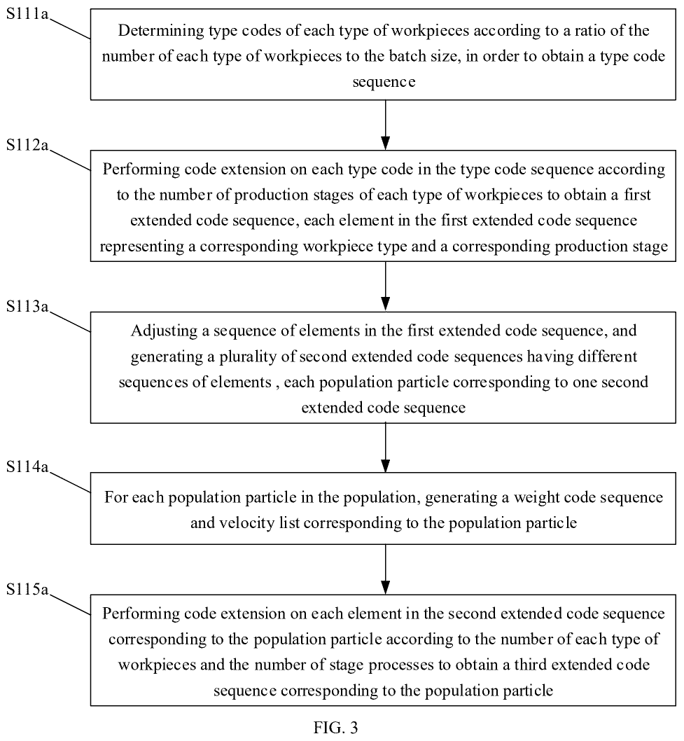

In some embodiments, the target iterative algorithm includes a first particle swarm algorithm which is used to perform production scheduling. The information on the to-be-produced workpieces includes types of to-be-produced workpieces, a number of each type of workpieces, a total number of processes of each type of workpieces, a number of stage processes corresponding to each production stage, and a batch size of batch production. FIG. 3 is a schematic flowchart of a specific implementation of S11 in FIG. 2. As shown in FIG. 3, in some embodiments, in S11, the generating the initialized population according to the information on the to-be-produced workpieces may further include the following steps S11a to S115a.

In S111a, type codes of each type of workpieces are determined according to a ratio of the number of each type of workpieces to the batch size, in order to obtain a type code sequence.

A number of type codes corresponding to each type of workpieces is determined according to the ratio of the number of each type of workpieces to the batch size, and the type codes of each type of workpieces are determined according to the number of type codes corresponding to each type of workpieces, thereby obtaining the type code sequence. The type code sequence contains the type codes corresponding to each type of workpieces. In the type code sequence, the type codes corresponding to each type of workpieces are set sequentially from small to large, and the smallest code in the type codes of the next type of workpieces follows the largest code in the type codes of the previous type of workpieces.

For each type of workpieces, if the ratio of the number of this type of workpieces to the batch size is an integer, the number of type codes corresponding to this type of workpieces is the ratio of the number of this type of workpieces to be produced to the batch size; and if the ratio of the number of this type of workpieces to the batch size is a non-integer, the number of type codes corresponding to this type of workpieces is obtained by dividing the number of workpieces to be produced for this type of workpieces by the batch size, rounding to obtain an integer and then adding the integer by 1.

It is assumed that workpieces of three types A, B, and C need to be produced, the numbers of workpieces to be produced for these three types of workpieces are X, Y, and Z respectively. A total number of processes required for producing each one of the workpieces of the type A is P, a total number of processes required for producing each one of the workpieces of the type B is Q, a total number of processes required for producing each one of the workpieces of the type C is N, and the workpieces of three types A, B, and C all meet the requirement that every T processes are one production stage. That is, the number of stage processes corresponding to each production stage is T. A number of production stages of each workpiece for each type of workpieces is a ratio of the corresponding total number of processes to the number of stage processes, and the batch size of batch production is M.

For the workpieces of the type A, the number of type codes for the workpieces of the type A is: X//M+1. That is, the number of workpieces of the type A to be produced is divided by the batch size, rounded and then added by 1. For example, X=50 and M=30, the number of type codes of the workpieces of the type A is 50//30+1=2, then the type codes of the workpieces of the type A may be configured as [0, 1], where 0 represents a first batch of the workpieces of the type A, 1 represents a second batch of the workpieces of the type A, and a number of each batch of workpieces is M=30.

The type coding is performed to the workpieces of the type B and the workpieces of the type C based on the same coding mode as the workpieces of the type A. For example, if the number of workpieces of the type B is Y=30 and M=30, the number of type codes of workpieces of the type B is Y/M=30/30=1, and the corresponding type code may be configured as [2]. If the number of workpieces of the type C is Z=30 and M=30, the number of type codes of the workpieces of the type C is Z/M=30/30=1, and the corresponding type code may be configured as [3]. Finally, a type code sequence [0, 1, 2, 3] is obtained according to the type codes of the workpieces of the type A, the type codes of the workpieces of the type B, and the type codes of the workpieces of the type C.

The type code sequence is generated according to the above rules, a correspondence relationship among each element and the types and number of the workpieces is recorded, and start and end points of workpiece numbers corresponding to each code are recorded according to actual situations. Taking the above type code sequence [0, 1, 2, 3] as an example, in the type code sequence, an element 0 represents workpieces Nos. 0-29 of the type A, an element 1 represents workpieces Nos. 30-49 of the type A, an element 2 represents workpieces Nos. 0-29 of the type B, an element 3 is workpieces Nos. 0-29, and so on.

In S112a, code extension is performed on each type code in the type code sequence according to the number of production stages of each type of workpieces to obtain a first extended code sequence, each element in the first extended code sequence representing a corresponding workpiece type and a corresponding production stage.

In some embodiments, a maximum number of production stages is determined according to the number of production stages of each type of workpieces. The type code sequence is repeated for the maximum number of production stages to obtain a new type code sequence. According to a sequence in which the same elements appear in the new type code sequence, each element is extended into a binary array to obtain the first extended code sequence. In the first extended code sequence, each element is a binary array. In each binary array, a first number represents the corresponding workpiece type and a second number represents the corresponding production stage.

Taking information on workpieces of the above three types A, B, and C as an example, a maximum value among the numbers P, Q, and N of the three types of workpieces is divided by the number T of stage processes, and the maximum number of production stages is obtained. If the maximum value among P, Q, and N is not a multiple of T, a ratio of this maximum value to T is rounded up to obtain the maximum number of production stages. For example: P/Q/N=5/4/3, T=3, then the maximum number of production stages is 5//3+1=2. The type code sequence generated in the previous step is repeated twice to obtain a new type code sequence. For example: if the type code sequence obtained in the previous step is [0, 1, 2, 3], this type code sequence is repeated twice to obtain a new type code sequence [0, 1, 2, 3, 0, 1, 2, 3]. According to a sequence in which the same elements appear in the new type code sequence, each element is extended into a binary array to obtain the first extended code sequence. For example, the first “0” is extended to (0, 1), the second “0” is extended to (0, 2), the first “1” is extended to (1, 1), and so on, till a first extended code sequence [(0, 1), (1, 1), (2, 1), (3, 1), (0, 2), (1, 2), (2, 2), (3, 2)] is obtained, where (0, 1) represents a first production stage of the first batch of the workpieces of the type A, (1, 1) represents a first production stage of the second batch of the workpieces of the type A, (2, 1) represents a first production stage of the first batch of the workpieces of the type B, (0, 2) represents a second production stage of the first batch of the workpieces of the type A, and so on.

When code extension is performed based on the maximum number of production stages, for a workpiece type whose number of production stages is less than the maximum number of production stages, the number of production stages reflected in the code sequence of that type of workpieces may be greater than its actual number of production stages. Therefore, in the subsequent production and machining, it is sufficient to set production time of the redundant production stage in the codes of this type of workpieces to 0.

In some embodiments, each type code corresponding to each type of workpieces in the type code sequence is repeated for a number of production stages of a corresponding type of workpieces according to the number of production stages of each type of workpieces to obtain a new type code sequence. The first extended code sequence is obtained. According to a sequence in which the same elements appear in the new type code sequence, each element is extended into a binary array to obtain the first extended code sequence. In the first extended code sequence, each element is a binary array. In each binary array, a first number represents the corresponding workpiece type and a second number represents the corresponding production stage.

Taking the information on the workpieces of the above three types A, B, and C as an example, assuming P/Q/N=5/4/3, a number of production stages of the workpieces of the type A is 5//3+1=2, a number of production stages of the workpieces of the type B is 4//3+1=2, and a number of production stages of the workpieces of the type C is 3/3=1. The type code sequence obtained in the previous step is [0, 1, 2, 3], where 0 and 1 are type codes corresponding to the workpieces of the type A, 2 is a type code corresponding to the workpieces of the type B, and 3 is a type code corresponding to the workpieces of the type C. “0” and “1” in the type code sequence [0, 1, 2, 3] are repeated twice respectively, “2” is repeated twice, and “3” is kept at 1 to obtain a new type code sequence [0, 1, 0, 1, 2, 2, 3]. According to a sequence in which the same elements appear in the new type code sequence, each element is extended into a binary array to obtain the first extended code sequence. For example, the first “0” is extended to (0, 1), the second “0” is extended to (0, 2), the first “1” is extended to (1, 1), and so on, till a first extended code sequence [(0, 1), (1, 1), (0, 2), (1, 2), (2, 1), (2, 2), (3, 1)] is obtained. (0, 1) represents a first production stage of the first batch of the workpieces of the type A, (1, 1) represents a first production stage of the second batch of the workpieces of the type A, (0, 2) represents a second production stage of the first batch of the workpieces of the type A, (2, 1) represents a first production stage of the first batch of the workpieces of the type B, and so on.

In S113a, a sequence of elements in the first extended code sequence is adjusted to generate a plurality of second extended code sequences having different sequences of elements, each population particle corresponding to one second extended code sequence.

In S113a, a plurality of first extended code sequences is copied, and a sequence of the elements in each first extended code sequence is adjusted, so that a plurality of second extended code sequences is obtained, where the sequences of the elements in the plurality of second extended code sequences are different from each other.

Meanwhile, in order to ensure the orderly production of the same batch of workpieces of the same type, in the second extended code sequence, the elements corresponding to the same batch of workpieces of the same type are sorted in a sequence of the corresponding production stages, and there may be other elements between any two adjacent elements of the workpieces of the same type and the same batch. The other elements may be different batches of workpieces corresponding to the workpieces of the same type, or may be elements corresponding to the workpieces of other types. For example, an element (0, 1) needs to be sequenced before an element (0, 2), and an element (1, 1) may be sequenced between the element (0, 1) and the element (0, 2).

Exemplarily, the first extended code sequence is: [(0, 1), (1, 1), (0, 2), (1, 2), (2, 1), (2, 2), (3, 1), (3, 2)]. By adjusting the sequence of the elements according to the above rule, a plurality of second extended code sequences is obtained, and the plurality of second extended code sequences are: [(0, 1), (1, 1), (0, 2), (1, 2), (2, 1), (2, 2), (3, 1), (3, 2)], [(1, 1), (0, 1), (1, 2), (0, 2), (2, 1), (3, 1), (2, 2), (3, 2)] and [(0, 1), (2, 1), (2, 2), (1, 1), (0, 2), (1, 2), (3, 1), (3, 2)].

In S114a, for each population particle in the population, a weight code sequence and velocity list corresponding to the population particle are generated.

The weight code sequence includes weight codes that are in one-to-one correspondence to the elements corresponding to the second extended code sequence, and the velocity list includes velocities that are in one-to-one correspondence to the elements corresponding to the second extended code sequence.

In some embodiments, the initial weight code sequence and velocity list may be randomly generated, and a length of each of the weight code sequence and the velocity list is a length of the second extended code sequence in the corresponding population particle.

Exemplarily, the initial weight code sequence may be an arithmetic sequence, e.g., [0, 1, 2, 3, 4, 5, 6, 7], with 0 as a starting element, a same length as that of the corresponding second extended code sequence, and a difference of 1 between adjacent elements, where each element represents a weight code of the corresponding element in the second extended code sequence.

The initial velocity list has the same length as that of the corresponding second extended code sequence, where a value of each element is a random value between a negative maximum velocity −v_max and a positive maximum velocity v_max. For example: the maximum speed v_max is set to 3, and then the initial velocity list may be configured as [−1, 0, 1, 2, 2.5, −0.1, . . . , −2, 3], where each element represents a velocity of the corresponding element in the second extended code sequence.

In S115a, code extension is performed on each element in the second extended code sequence corresponding to the population particle according to the number of each type of workpieces and the number of stage processes to obtain a third extended code sequence corresponding to the population particle.

Each element in the third extended code sequence represents a workpiece number of one workpiece and one stage process in the corresponding production stage, and the third extended code sequence represents one production scheduling scheme.

Exemplarily, it is assumed that there are two types of workpieces, where two workpieces need to be produced for one type of workpieces, and three workpieces need to be produced for the other type of workpieces, with a batch size of 3. The number of production stages of both types of workpieces is 2, and the number of stage processes in each production stage is 3. A second extended code sequence obtained according to the above coding mode is [(0, 1), (1, 1), (0, 2), (1, 2)]. In the second extended code sequence, (0, 1) represents a first production stage of the first type of workpieces, (0, 2) represents a second production stage of the first type of workpieces, (1, 1) represents a first production stage of the second type of workpieces, and (1, 2) represents a second production stage of the second type of workpieces. The elements (0, 1) and (0, 2) in the second extended code sequence are extended respectively according to the number of workpieces that need to be produced for the first type of workpieces 2 and the number of stage processes 3. The elements (1, 1) and (1, 2) in the second extended code sequence are extended respectively according to the number of workpieces that need to be produced for the second type of workpieces 3 and the number of stage processes 3.

For the first type of workpieces, the workpieces that need to be produced for the first type of workpieces are firstly numbered, such as 0 and 1, which represent the 0^{th} workpiece and the first workpiece respectively. The stage processes of the first production stage of the first type of workpieces are numbered, such as 1, 2, 3, which represent a first stage process, a second stage process and a third stage process of the first production stage respectively. The stage processes of the second production stage of the first type of workpieces are numbered, such as 3, 4, 5, which represent a first stage process, a second stage process and a third stage process of the second production stage respectively. The corresponding elements in the second extended code sequence are extended based on the workpiece numbers and the stage process numbers of the workpieces that need to be produced for the first type of workpieces. For example, the element (0, 1) is extended to [(0, 1), (0, 2), (0, 3), (1, 1), (1, 2), (1, 3)] and the element (0, 2) is extended to [(0, 3), (0, 4), (0, 5), (1, 3), (1, 4), (1, 5)]. In a binary array of each extended element, a first number represents a workpiece number and a second number represents a stage process number.

For the second type of workpieces, the workpieces that need to be produced for the second type of workpieces are firstly numbered, such as 2, 3 and 4, which represent a first workpiece, a second workpiece and a third workpiece respectively. The stage processes of the first production stage of the second type of workpieces are numbered, such as 1, 2, 3, which represent a first stage process, a second stage process and a third stage process of the first production stage respectively. The stage processes of the second production stage of the second type of workpieces are numbered, such as 3, 4, 5, which represent a first stage process, a second stage process and a third stage process of the second production stage respectively. The corresponding elements in the second extended code sequence are extended based on the workpiece numbers and the stage process numbers of the workpieces that need to be produced for the second type of workpieces. For example, the element (1, 1) is extended to [(2, 1), (2, 2), (2, 3), (3, 1), (3, 2), (3, 3), (4, 1), (4, 2), (4, 3)], and the element (1, 2) is extended to [(2, 3), (2, 4), (2, 5), (3, 3), (3, 4), (3, 5), (4, 3), (4, 4), (4, 5)]. In a binary array of each extended element, a first number represents a workpiece number and a second number represents a stage process number.

In the third extended code sequence, the elements corresponding to the same workpiece and the same production stage are sorted in a sequence of the stage processes. Each third extended code sequence represents a production scheduling scheme, and the sequence of the elements in the third extended code sequence represents a production scheduling sequence of the corresponding workpieces.

In some embodiments, the to-be-produced workpieces and the processes are coded by the coding mode of the above-mentioned steps S111a to S115a. Finally, the third extended code sequence obtained based on the coding is used as a production scheduling scheme for production and machining, which can effectively ensure the production of a batch of workpieces of the same type of workpieces. The production device does not need to be switched, which avoids the crossover production of different types of workpieces, ensures the saturation used in batch production and the production device, effectively avoids the idle situation of mixed production and the production device, increases a device utilization rate and shortens the maximum makespan.

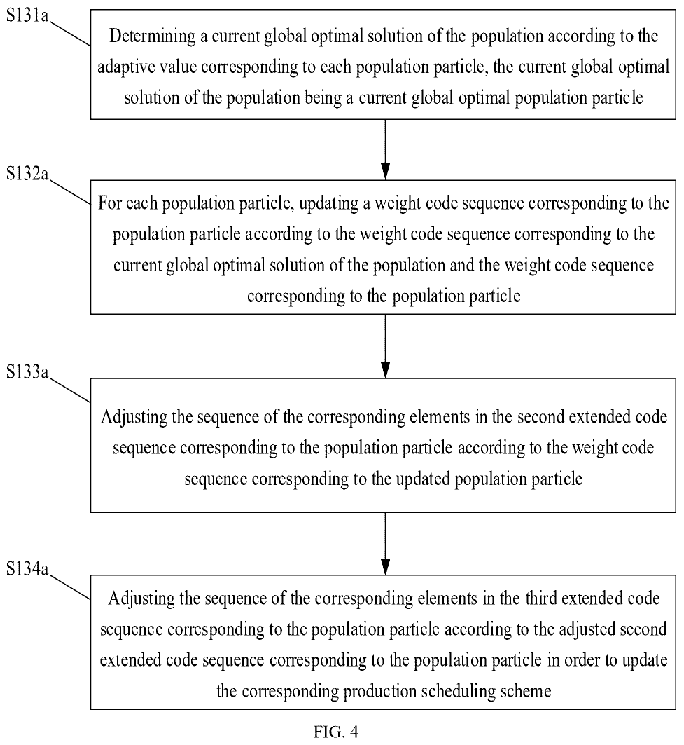

FIG. 4 is a schematic flowchart of a specific implementation of S13 in FIG. 2. In some embodiments, in the case that the to-be-produced workpieces and the processes are coded based on the coding mode of the above-mentioned steps S111a to S115a, each population particle is updated and evolved according to the first particle swarm algorithm. As shown in FIG. 4, in S13, the performing the iterative updating on the population according to the adaptive value based on the target iterative algorithm may further include the following steps S131a to S134a.

In S131a, a current global optimal solution of the population is determined according to the adaptive value corresponding to each population particle, the current global optimal solution of the population being a current global optimal population particle.

The current global optimal solution of the population is determined in the current iteration round according to a minimum value among the adaptive values corresponding to a plurality of population particles in the population, and the current global optimal solution of the population is a current global optimal population particle, that is, the population particle corresponding to the minimum value among the adaptive values corresponding to the plurality of population particles.

In some embodiments, for each population particle, the current individual optimal solution of this population particle is determined according to a minimum value among the adaptive values of this population particle in a historical iteration round and the current round.

In S132a, for each population particle, a weight code sequence corresponding to the population particle is updated according to the weight code sequence corresponding to the current global optimal solution of the population and the weight code sequence corresponding to the population particle.

Weight codes corresponding to the same extended code sequence element in the weight code sequence corresponding to the current global optimal solution and in the weight code sequence corresponding to the population particle are subtracted to obtain new weight codes. The new weight codes are sequenced from small to large, resulting in a new weight code sequence.

Exemplarily, the second extended code sequence of the current population particle is [(0, 1), (0, 2), (1, 1)], and its weight code sequence is [1, 2, 3]. The second extended code sequence of the current global optimal population particle is [(1, 1), (0, 1), (0, 2)], and its weight code sequence is [1, 2, 3]. It can be seen that the corresponding weight code of the extended code sequence element (0, 1) in the current population particle is 1, and the corresponding weight code in the optimal population particle is 2; the corresponding weight code of the extended code sequence element (0, 2) in the current population particle is 2, and the corresponding weight code in the optimal population particle is 3; and the corresponding weight code of the extended code sequence element (1, 1) in the current population particle is 3, and the corresponding weight code in the optimal population particle is 1. If the weight code of the optimal population particle is subtracted from the weight code of the current population particle in a manner of corresponding to the same extended code sequence element, a result of subtraction of the weight code corresponding to the same extended code sequence element is [2−1, 3−2, 1−3]=[1, 1, −2]. The sequence result from small to large is [−2, 1, 1], that is, a new weight code sequence is [−2, 1, 1]. In the new weight code sequence, an extended code sequence element corresponding to “−2” is (1, 1), an extended code sequence element corresponding to the first “1” is (0, 1), and an extended code sequence element corresponding to the second “1” is (0, 2).

In S133a, the sequence of the corresponding elements in the second extended code sequence corresponding to the population particle is adjusted according to the updated weight code sequence corresponding to the population particle.

The sequence of the corresponding elements in the second extended code sequence corresponding to the population particle is adjusted based on the sequence of the weight codes in the new weight code sequence to obtain a new second extended code sequence corresponding to the population particle.

Exemplarily, the second extended code sequence of the current population particle is [(0, 1), (0, 2), (1, 1)], and an original weight code sequence is [1, 2, 3]; and a second extended code sequence of the current global optimal population particle is [(1, 1), (0, 1), (0, 2)], and its weight code sequence is [1, 2, 3]. The new weight code sequence calculated according to the above step S132a is [−2, 1, 1]. In the new weight code sequence, an extended code sequence element corresponding to “−2” is (1,1), an extended code sequence element corresponding to the first “1” is (0, 1), and an extended code sequence element corresponding to the second “1” is (0, 2). Based on the sequence of the weight codes in the new weight code sequence, the sequence of the corresponding elements in the second extended code sequence corresponding to the population particle is adjusted to obtain a new second extended code sequence [(1, 1), (0, 1), (0, 2)]. It can be seen that the population particle moves towards the optimal population particle.

In some embodiments, for the same type of workpieces, it is necessary to produce them sequentially in the order of production stages, not in reverse order. Therefore, in the adjusted second extended code sequence, for elements corresponding to the same type of workpieces, when there is a case where the elements corresponding to the next production stage are located before the elements corresponding to the previous production stage, the sequence of the elements that will cause the production stage to be reversed is adjusted so that the elements corresponding to the same type of workpieces are sorted in a sequence of the production stages. For example, the adjusted second extended code sequence is [(0, 2), (1, 1), (0, 1), (1, 2)], where (0, 2) preceding (0, 1) will lead to reverse production of the production stages, so the adjusted second extended code sequence is further adjusted to [(0, 0), (1, 0), (0, 1), (1, 1)].

In some embodiments, it is also necessary to update a velocity of the population particle according to a current individual optimal solution of the population particle and the current global optimal solution of the population to update the velocity list corresponding to the corresponding second extended code sequence.

In S134a, the sequence of the corresponding elements in the third extended code sequence corresponding to the population particle is adjusted according to the adjusted second extended code sequence corresponding to the population particle in order to update the corresponding production scheduling scheme.

It can be seen from the description of the above step S115a that an element in the third code sequence is an extended code of the element in the corresponding second extended code sequence. Therefore, each element in the second extended code sequence has a correspondence relationship with a corresponding element in the corresponding third code sequence. Therefore, when the sequence of the elements in the second extended code sequence is updated, the sequence of the corresponding elements in the corresponding third extended code sequence also needs to be adjusted. The sequence of the corresponding elements in the third extended code sequence corresponding to the population particle is adjusted according to the sequence of the elements in the adjusted second extended code sequence corresponding to the population particle, so as to update the corresponding production scheduling scheme.

After the population is updated, if the current iteration round does not exceed an iteration round threshold, the current iteration round enters the next iteration round and returns to S12.

In some embodiments, the target iterative algorithm includes a genetic algorithm which is used to perform production scheduling. The workpiece information includes types of to-be-produced workpieces, a number of each type of workpieces, and a batch size of batch production. FIG. 5 is a schematic flowchart of another specific implementation of S11 in FIG. 2. As shown in FIG. 5, in some embodiments, in S11, the generating the initialized population according to the information on the to-be-produced workpieces may further include the following steps S111b to S112b.

In S111b, chromosome coding is performed according to the types of to-be-produced workpieces to obtain a plurality of type chromosome coding sequences.

Exemplarily, workpieces of four types A, B, C, and D need to be produced this time, and then a type chromosome code has a length of 4. The four types of workpieces are subjected to chromosome coding, e.g., A: 0, B: 1, C: 2, D: 3. Based on this, a plurality of type chromosome coding sequences having a plurality of different element sequences, such as [0, 1, 2, 3] and [3, 0, 1, 2], may be obtained. The sequence of the elements in different type chromosome coding sequences is different. That is, the sequence of the coding elements corresponding to at least one type of workpieces is different. In the type chromosome coding sequence, each element represents a chromosomal code of a type of workpieces.

In S112b, each type chromosome coding sequence is decoded according to the number of each type of workpieces to obtain an individual chromosome decoding sequence corresponding to each type chromosome coding sequence.

Each element in the individual chromosome decoding sequence represents a workpiece number of each workpiece corresponding to the workpiece type, and each individual chromosome decoding sequence represents one production scheduling scheme.

It is assumed that two, three, four and two workpieces need to be produced respectively for the workpieces of four types A, B, C, and D. For example, the workpiece numbers of the two workpieces of the type A may be configured as 0, 1, the workpiece numbers of the three workpieces of the type B may be configured as: 2, 3, 4, the workpiece numbers of the four workpieces of the type C may be configured as: 5, 6, 7, 8, and the workpiece numbers of the two workpieces of the type D may be configured as: 9, 10. A corresponding individual chromosome coding sequence [0, 1, 2, 3, 4, 5, 6, 7, 8, 9, 10] may be obtained by decoding type chromosome codes [0, 1, 2, 3]. The corresponding individual chromosome coding sequence [9, 10, 0, 1, 5, 6, 7, 8, 2, 3, 4] may be obtained by decoding type chromosome codes [3, 0, 2, 1]. In the individual chromosome coding sequence, each element represents a workpiece number of one workpiece among a corresponding type of workpieces, each individual chromosome decoding sequence represents one production scheduling scheme, and the sequence of the elements in the individual chromosome decoding sequence represents a production scheduling sequence of the corresponding workpieces.

Through the genetic algorithm coding and decoding in the above-mentioned steps S111b to S112b, the workpieces of the same type are coded and decoded in batches to obtain the type chromosome coding sequence and the individual chromosome coding sequence. Each element in the type chromosome coding sequence represents each batch of a type of workpieces in batch production. The subsequent genetic operations such as selection, crossover and mutation in the genetic algorithm are all operated for the type chromosome coding sequence, so as to ensure that the same operation is performed for the workpieces of this type and this batch and thus the consistency is ensured. The individual chromosome coding sequence is based on the type chromosome coding sequence and is obtained by decoding the number of each type of workpieces and the workpiecenumbers of the workpieces. The decoded individual chromosome coding sequence is used for the subsequent distribution and production of the production device. After production, the makespan of the last produced workpiece among the workpieces of this type and this batch is taken as the makespan for the workpieces of this type and this batch. The genetic operation is performed on the type code sequence according to the makespan for the workpieces of each type and each batch, and then put into production again. The optimal solution is obtained based on the genetic algorithm. In this way, the production time is minimized, and the needs of batch production of the same type of workpieces are satisfied to avoid the crossover production of the same type of workpieces, which can effectively ensure the production of a batch of workpieces of the same type of workpieces. The production device does not need to be switched, which ensures the saturation used in batch production and the production device, effectively avoids the idle situation of mixed production and the production device, increases a device utilization rate and shortens the maximum makespan.

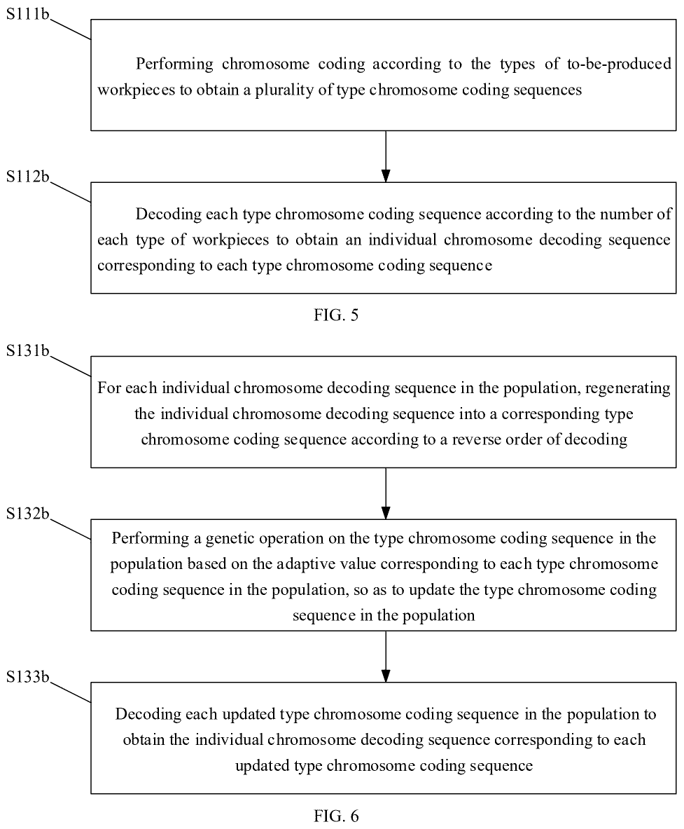

FIG. 6 is a schematic flowchart of a specific implementation of S13 in FIG. 2. In some embodiments, in the case that the genetic algorithm is coded and decoded based on the coding mode of the above-mentioned steps S111b to S112. As shown in FIG. 6, in S13, the performing the iterative updating on the population according to the adaptive value based on the target iterative algorithm may further include the following steps S131b to S133b.

In S131b, for each individual chromosome decoding sequence in the population, the individual chromosome decoding sequence is regenerated into a corresponding type chromosome coding sequence according to a reverse order of decoding.

For example, if the individual chromosome coding sequence [0, 1, 2, 3, 4, 5, 6, 7, 8, 9, 10], the corresponding type chromosome coding sequence [0, 1, 2, 3] is obtained by processing according to a reverse order of decoding in S112a.

In S132b, a genetic operation is performed on the type chromosome coding sequence in the population based on the adaptive value corresponding to each type chromosome coding sequence in the population, so as to update the type chromosome coding sequence in the population.

The genetic operations include selection, crossover and mutation.

In the genetic algorithm, the selection operation refers to the selection of excellent individuals from the current population with a certain probability to form a new population, in order to reproduce to get individuals in the next generation of the population. The probability of the individual being selected is related to the adaptive value, the higher the adaptive value of the individual, and the greater the probability of it being selected.

The crossover operation refers to the random selection of two individuals from the population. Excellent characteristics of a parent string are inherited to a child string through an exchange combination of two chromosome codes, so as to produce new excellent individuals.

The mutation operation is the replacement of gene values on some loci in the type chromosome coding sequence with other alleles of these loci to form a new individual.

The current population is subjected to the selection operation, the crossover operation and the mutation operation to obtain a next-generation population.

In S133b, each updated type chromosome coding sequence in the population is decoded to obtain the individual chromosome decoding sequence corresponding to each updated type chromosome coding sequence.

The description of S133b may refer to the description of S112b above, which will not be repeated here.

In some embodiments, the target iterative algorithm includes a second particle swarm algorithm which is used for production scheduling. The information on to-be-produced workpieces includes a number of to-be-produced workpieces, and a number of processes for each workpiece. The FJSP problem may be described as follows: n workpieces are arranged to be produced and machined on m production devices, each workpiece containing s processes that are executed in sequence. The machining time of each process of each workpiece on the production device is known. A production scheduling scheme is formulated for these workpieces, for the purpose of optimizing the maximum makespan, that is, the total machining time to complete all processes of all workpieces is the shortest.

Prior to initializing the population, production scheduling constraints are constructed:
constraint 1: each process is to perform machining on a specified production device, and the machining must be started after the previous process is completed;
constraint 2: one production device can only machine one workpiece at a time;
constraint 3: each workpiece can only be machined once on one production device; and
constraint 4: the process sequence and machining time of each workpiece are known, and do not change with the change of machining sequence.

FIG. 7 is a schematic flowchart of another specific implementation of S11 in FIG. 2. As shown in FIG. 7, in some embodiments, in S11, the generating the initialized population according to the information on the to-be-produced workpieces may further include the following steps S111c to S112c.

In S111c, a plurality of production scheduling schemes is generated according to the number of to-be-produced workpieces and the number of processes of each workpiece, each production scheduling scheme corresponding to one population particle.

The population is initialized randomly. A plurality of production scheduling schemes is generated according to the number of to-be-produced workpieces and the number of process of each workpiece, each production scheduling scheme corresponding to one population particle. Exemplarily, there are five workpieces A, B, C, D, and E, each workpiece has three processes, and each production scheduling scheme represents a machining sequence of each process of the five workpieces. For example, a production scheduling scheme is BADCEABDCEBADEC, where the times of occurrences of each workpiece indicates the number of processes. For example, the first occurrence of B indicates a first process of the workpiece B, and the second occurrence of B indicates a second process of the workpiece B.

Prior to initializing the population, an iteration round threshold and a number of population particles in each iteration may be set first. For example, the iteration round threshold may be set to 100 and the number of population particles in each iteration may be set to 50.

In S112c, inertia weight, position and velocity parameters corresponding to each population particle are randomly initialized.

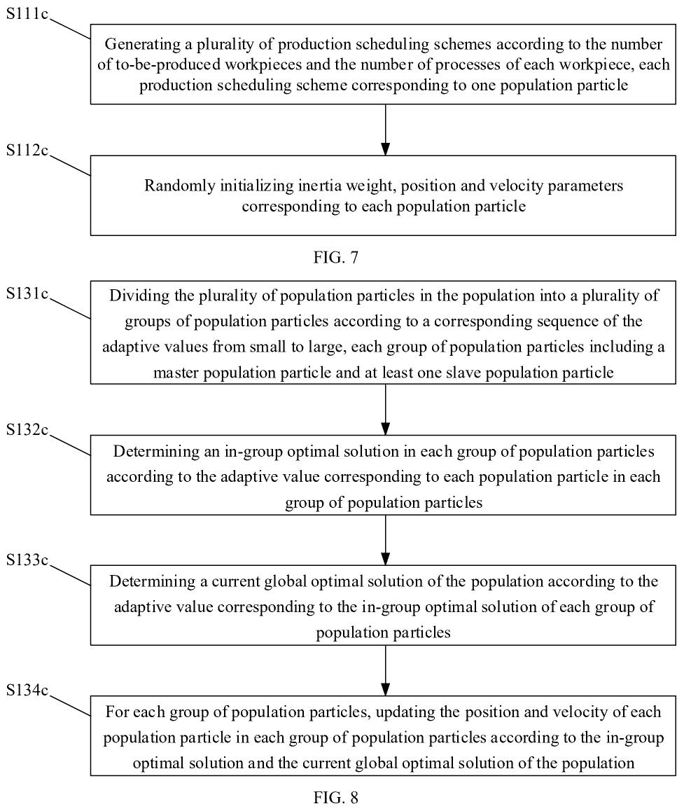

FIG. 8 is a schematic flowchart of another specific implementation of S13 in FIG. 2. In some embodiments, in the case that the population is initialized using the particle swarm algorithm based on the above steps S111c to S112c, referring to FIG. 8, the performing the iterative updating on the population based on the adaptive value in S13 may further include the following steps S131c to S134c.

In S131c, the plurality of population particles in the population is divided into a plurality of groups of population particles according to a corresponding sequence of the adaptive values from small to large, each group of population particles including a master population particle and at least one slave population particle.

For example, the population has fifty population particles. The fifty population particles are sequentially divided into five groups according to a sequence of adaptive values corresponding to each population particle in the current iteration round from small to large and each group contains ten population particles. One population particle is randomly selected in each group as a master population particle, the other population particles are slave population particles, and the master population particle in the i^{th} group is identified as a master population particle i (i=1, 2, . . . , 10).

In S132c, an in-group optimal solution in each group of population particles is determined according to the adaptive value corresponding to each population particle in each group of population particles.

The in-group optimal solution is a population particle corresponding to a minimum value among the adaptive values of all population particles in a group, and a position of the master population particle is a position of the population particle corresponding to the in-group optimal solution.

In S133c, a current global optimal solution of the population is determined according to the adaptive value corresponding to the in-group optimal solution of each group of population particles, the current global optimal solution being an in-group optimal solution corresponding to the minimum adaptive value.

In S134c, for each group of population particles, the position and velocity of each population particle in each group of population particles are updated according to the in-group optimal solution and the current global optimal solution of the population.

The position and velocity of the particle are multidimensional vectors, and a value of each dimension is updated according to a position updating formula and a velocity updating formula.

The velocity updating formula is as follows:

$${v}_{id}^{k} = ω {v}_{id}^{k - 1} + {c}_{1} {r}_{1} ( {pbest}_{id} - {x}_{id}^{k - 1} ) + {c}_{2} {r}_{2} ( {gbest}_{d} - {x}_{id}^{k - 1} ) ;$$

and
the position updating formula is as follows:

$${x}_{id}^{k} = {x}_{id}^{k - 1} + {v}_{id}^{k - 1}$$

in which, V^{k}_{id} represents a d-dimensional component of a velocity of a master population particle i in an i^{th} group in a k^{th} iteration round; x^{k}_{id} represents a d-dimensional component of a position of the master population particle i in the i^{th} group in the k^{th} iteration round; c₁ and c₂ are acceleration constants, which are used to adjust a maximum learning step size; r₁ and r₂ are two random functions each having a value range of [0, 1] and used to increase the search randomness; w represents an inertia weight, which is a non-negative number and is used to adjust a search range of a solution space; pbest_{id} represents a best position experienced by the master population particle i in the i^{th} group, that is, the position of the optimal solution in the current in-group optimal solution and the historical in-group optimal solution in the i^{th} group; and gbest_{id} represents the best position experienced by the population, i.e., the position of the current global optimal solution of the population.

In some embodiments, in the iterative updating process of the population, the population particles are divided into a plurality of groups, a master population particle is selected for each group, and the others are slave population particles. Even if a master population particle of one group falls into a local optimal solution, the master population particles of other groups may still continue to search, which can effectively avoid the phenomenon that the algorithm cannot effectively obtain the global optimal solution because it is trapped in the local optimal solution, and effectively improve the phenomenon that the algorithm is trapped in the local optimal solution.

In some embodiments, in the case that the population is iteratively updated based on the updating mode of the above step S131c to step S134c, after performing iterative updating on the population according to the adaptive value based on the target iterative algorithm, the production scheduling method further includes: determining inert population particles in the population according to a historical velocity and a historical position of each population particle in the population; and eliminating the inert population particles from the population, and adding a corresponding number of new population particles to the population.

Because the inert population particle has less effect on the convergence of the algorithm, but occupies computing resources, the inert population particle needs to be eliminated. After elimination, the same number of new population particles are added. An initialization mode of the new population particles may refer to the above step S111c, which will not be repeated here.

Specifically, the determining the inert population particles in the population according to the historical velocity and the historical position of each population particle in the population includes: determining the population particles to be the inert population particles in response to a variation in the plurality of historical velocities of the population particles being less than a first threshold, and a variation in the plurality of historical positions of the population particles being less than a second threshold. The first threshold and the second threshold may be set according to actual needs, which will not be specially limited in the embodiments of the present disclosure.

The population particles are determined not to be the inert population particles in response to the variation in the plurality of historical velocities of the population particles being greater than or equal to the first threshold, and the variation in the plurality of historical positions of the population particles being greater than or equal to the second threshold.

In some embodiments, a convergence speed of the algorithm can be effectively accelerated by eliminating the inert population particles from the population.

In some embodiments, in S12, for each production scheduling scheme in the population, the acquiring the adaptive value corresponding to the production scheduling scheme may further include: selecting a corresponding production device to produce and machine a workpiece according to the production scheduling scheme, and acquiring production makespan; and acquiring an adaptive value corresponding to the production scheduling scheme according to the production makespan based on a preset adaptive value function.

The preset adaptive value function may be determined according to the particle swarm algorithm or genetic algorithm actually adopted, and the adaptive value corresponding to the production scheduling scheme may be acquired according to the adaptive value function.

In some embodiments, the selecting the corresponding production device to produce and machine the workpiece according to the production scheduling scheme may further include: selecting the corresponding production device for each to-be-processed workpiece in the production scheduling scheme for workpiece machining and production according to the last makespan of each production device in a production device set; acquiring device maintenance information; in response to the selected production device being determined to be in a maintenance state according to the device maintenance information, adjusting the last makespan of the production device that is in the maintenance state in the production device set to maintenance end time; and returning again to the step of selecting the corresponding production device for each to-be-produced workpiece in the production scheduling scheme for workpiece machining and production according to the last makespan of each production device in the production device set.

The production device corresponding to the last makespan with the longest distance from the start of machining this time, that is, the production device that is the earliest idle production device in the production device set, is found according the last makespan of each production device in the production device set based on the principle of shortest time allocation; and the production device is selected for workpiece production and machining. For example, if a workpiece 0 should be produced at this time, but there are two available production devices, the production device corresponding to the last makespan with the longest distance from the start of machining is selected from these two devices for production and machining.

When it is determined that the selected production device is undergoing maintenance according to device state information, the last makespan of the selected production device is set as the maintenance end time, and the step of selecting the corresponding production device for workpiece machining and production for each to-be-produced workpiece in the production scheduling scheme returns again according to the last makespan of each production device in the production device set, so that the production device is re-selected for production and machining according to the last makespan of each production device in the updated production device set. If the selected production device is not in a maintenance state during a production period, the production device is used directly for production.

After the production and machining are completed based on the production scheduling scheme, production and machining information and device state information of the production scheduling scheme are recorded and updated.

In some embodiments, whether a production device is under maintenance is determined while the production device is selected for production and machining so as to determine all production devices under maintenance during the production period, and the last makespan of these production devices is adjusted to its maintenance end time. In this way, the production device that is in a maintenance state cannot be selected in the selection course of the production devices according to the principle of shortest time allocation. The determination of the maintenance state of the device and the selection of the production device are performed through the device state information, such that the entire production scheduling is more suitable for a real workshop scheduling scene and is more practical.

In some embodiments, in the actual workshop scheduling production, the workpieces may be produced through a plurality of processes, and presents certain cycle characteristics. In the course of selecting the production device, the same production device may also be reused for producing and machining against a plurality of production processes for a workpiece. For example, each type of to-be-produced workpieces satisfies that every three processes are regarded as one production stage, that is, the number of stage processes corresponding to each production stage is 3. Assuming that the production of a type of workpieces requires six processes, the same production device may be used for production in the 1st/2nd/3rd and 4th/5th/6th processes.

In the embodiments of the present disclosure, when the current iteration round exceeds the iteration round threshold or the position of the global optimal solution meets a minimum bound, the algorithm iteration is stopped.

In this embodiment of the present disclosure, in S15, the target optimal solution is determined according to the minimum value among the adaptive values corresponding to the global optimal solution generated in each iteration round. The target optimal solution is a global optimal solution corresponding to the minimum adaptive value. The production scheduling scheme corresponding to the target optimal solution is taken as the target production scheduling scheme.

At this point, the target production scheduling scheme is outputted, and the production and machining information during the production and machining based on the target production scheduling scheme is recorded at the same time, the production and machining information including the production device, machining start time and machining end time corresponding to each process of each workpiece. The target production scheduling scheme and the corresponding production and machining information may be used to guide a factory to formulate a production plan, which may not only increase a utilization rate of the production device, but also effectively complete a machining task of the corresponding workpiece within the shortest time, and maximally satisfy a workpiece production and delivery plan.

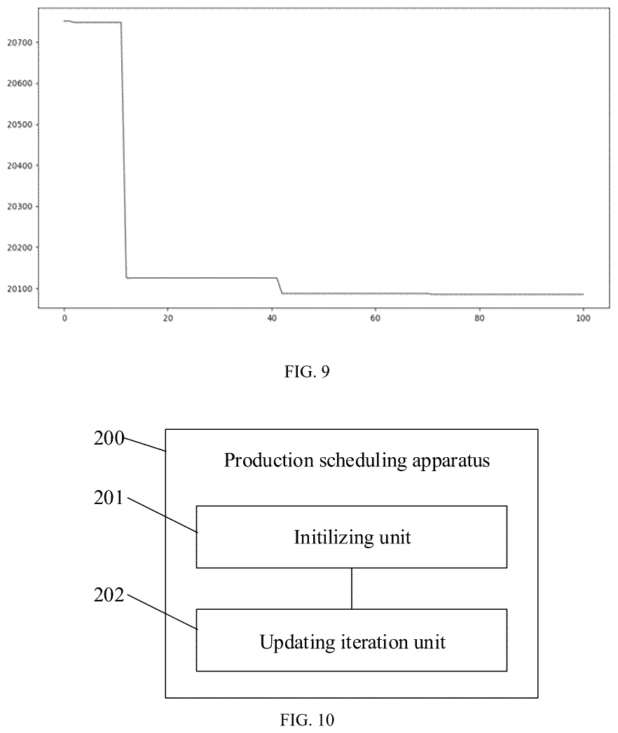

Table 1 shows a production scheduling sequence in an exemplary initialized production scheduling scheme. Table 2 shows production time of each stage process of each workpiece in each production stage in an exemplary production scheduling scheme. Table 3 shows exemplary device maintenance state records of different types of production devices. FIG. 9 is a schematic diagram of changes in production makespan of a production scheduling scheme in an iterative updating process using a target iterative algorithm according to an embodiment of the present disclosure. In an actual application scenario, as shown in FIG. 9, the abscissa represents an iteration round, and the ordinate represents the production makespan of the production scheduling scheme. After comparison, under the same commissioning plan, the time for production scheduling of the original production scheduling scheme is three days. The target iterative algorithm of the present disclosure is used to iteratively update the production scheduling scheme, and an appropriate production device is selected based on the device state shown in Table 3 for production according to the production scheduling scheme. After the algorithm is iteratively updated, the production scheduling time is greatly shortened to 20,100 seconds, that is, 5.6 hours. That is, the production scheduling method in this embodiment of the present disclosure can effectively shorten the production makespan required by the production scheduling scheme, and effectively improve the production efficiency.

TABLE 1

| Type of | Number of | | Day | Day |
|---|---|---|---|---|
| workpieces | workpieces | Day n | (n + 1) | (n + 2) |
| A | 220 | 100 | 100 | 20 |
| B | 300 | 100 | 100 | 100 |
| C | 80 | 0 | 0 | 80 |
| D | 300 | 100 | 100 | 100 |

TABLE 2

| | | Time (second) | | |
|---|---|---|---|---|
| Type of | Production | Stage | Stage | Stage |
| workpieces | stage | process 1 | process 2 | process 3 |
| A | 1 | 87 | 87 | 84 |
| | 2 | 88 | 83 | 82 |
| | 3 | 88 | 88 | 83 |
| | 4 | 81 | 85 | 82 |
| | 5 | 81 | 89 | 89 |
| B | 1 | 81 | 84 | 89 |
| | 2 | 81 | 87 | 87 |
| | 3 | 83 | 87 | 82 |
| | 4 | 87 | 89 | 87 |
| C | 1 | 85 | 86 | 89 |
| | 2 | 82 | 88 | 84 |
| | 3 | 83 | 83 | 82 |
| D | 1 | 83 | 80 | 80 |
| | 2 | 89 | 82 | 84 |
| | 3 | 89 | 86 | 82 |
| | 4 | 88 | 85 | 88 |

TABLE 3

| Type of | | | | | | | | | |
|---|---|---|---|---|---|---|---|---|---|
| production | Serial | Day | Day | Day | Day | Day | Day | Day | Day |
| devices | No. | m | (m + 1) | (m + 2) | (m + 3) | (m + 4) | (m + 5) | (m + 6) | (m + 7) |
| 1 | #1 | | | | | | | | |
| | #2 | | | | | | 18:00- | | |
| | | | | | | | 20:00 | | |
| | #3 | | | 0:00- | | | | | |
| | | | | 8:00 | | | | | |
| | #4 | 0:00- | | | | | | | |
| | | 12:00 | | | | | | | |
| | #5 | | | | | | | | |
| | #6 | | | | | | | | |
| | #7 | | | | | | | | |
| | #8 | | | | | | | | |
| | #9 | | | | | | | | |
| 2 | #1 | | | | | | | | |
| | #2 | | | | | | | 6:00 | |
| | #3 | | | | | 0:00- | | | |
| | | | | | | 23:00 | | | |
| | #4 | | | | 17:00- | | | | |
| | | | | | 23:00 | | | | |
| | #5 | | 15:00- | | | | | | |
| | | | 19:00 | | | | | | |
| 3 | #1 | 0:00- | | | | | | | |
| | | 24:00 | | | | | | | |
| | #2 | | 0:00- | | | | | | |
| | | | 24:00 | | | | | | |
| | #3 | | | | | | | | |
| | #4 | | | | 14:00- | | | | |
| | | | | | 20:00 | | | | |
| | #5 | | | | | | | | |
| | #6 | | | | 14:00- | | | | |
| | | | | | 20:00 | | | | |

It may be understood that the above-mentioned method embodiments mentioned in the present disclosure may, without violating the logic of the principle, be combined with each other to form a combined embodiment, and will not be repeated in the present disclosure due to space limitations. Those skilled in the art may understand that in the above-mentioned method of the specific implementation, the specific order of execution of each step shall be determined by its function and possible internal logic.

FIG. 10 is a schematic structural diagram of a production scheduling apparatus for a flexible job shop provided according to an embodiment of the present disclosure. As shown in FIG. 10, the production scheduling method 200 includes an initializing unit 201 and an updating iteration unit 202.

The initializing unit 201 is configured to generate an initialized population according to information on to-be-produced workpieces, the population includes a plurality of production scheduling schemes, and the production scheduling schemes represents a production scheduling sequence of the to-be-produced workpieces.

The updating iteration unit 202 is configured to perform iterative updating on the population based on a preset target iterative algorithm and determine a target production scheduling scheme according to an iteration process.

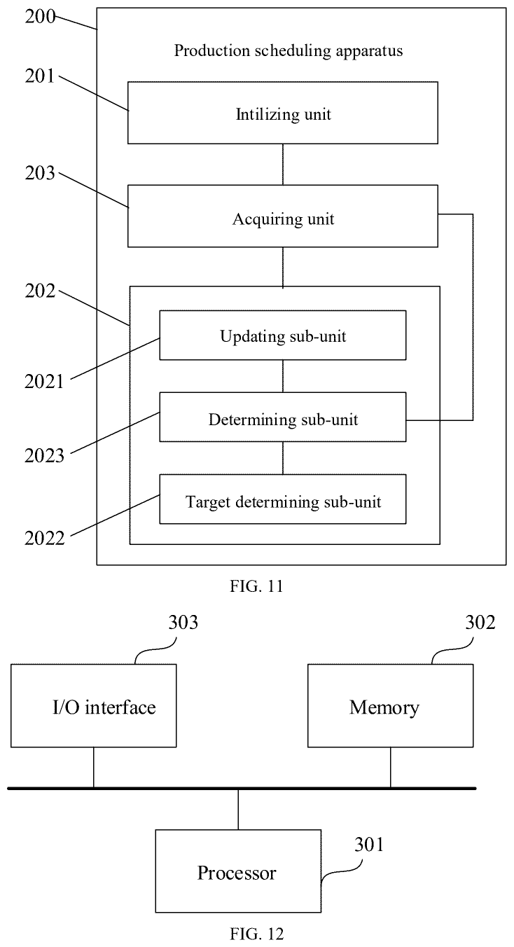

FIG. 11 is a schematic structural diagram of another production and scheduling apparatus for a flexible job shop according to an embodiment of the present disclosure. As shown in FIG. 11, the production scheduling apparatus 200 further includes an acquiring unit 203.

The acquiring unit 203 is configured to, for each production scheduling scheme in the population, acquire an adaptive value corresponding to the production scheduling scheme, and the adaptive value represents a production makespan corresponding to the production scheduling scheme.

The updating iteration unit 202 includes an updating sub-unit 2021 and a target determining sub-unit 2022. The updating sub-unit 2021 is configured to perform iterative updating on the population according to the adaptive value based on a target iterative algorithm. The target determining sub-unit 2022 is configured to determine a target production scheduling scheme according to an optimal solution obtained in the iteration process.

In some embodiments, as shown in FIG. 11, the updating iteration unit 202 further includes a determining sub-unit 2023. The determining sub-unit 2023 is configured to determine whether a current iteration round exceeds an iteration round threshold after the updating sub-unit 2021 performs iterative updating on the population. In response to the current iteration round not exceeding the iteration round threshold, the acquiring unit 203 is triggered to execute the step of acquiring the adaptive value corresponding to the production scheduling scheme for each production scheduling scheme in the population. In response to the current iteration round exceeding the iteration round threshold, the target determining sub-unit 2022 is triggered to execute the step of determining the target production scheduling scheme based on the optimal solution obtained in the iteration process.

The production scheduling apparatus 200 for the flexible job shop provided in this embodiment of the present disclosure is configured to implement the production scheduling method provided by any of the above embodiments. The specific relevant description may refer to the description in the production scheduling method of any of the above embodiments, which will not be repeated herein.

FIG. 12 is a block diagram of an electronic device according to an embodiment of the present disclosure.

Referring to FIG. 12, an embodiment of the present disclosure provides an electronic device. The electronic device includes at least one processor 301, at least one memory 302, and one or more I/O interfaces 303 connected between the processor 301 and the memory 302. The memory 302 is configured to store one or more computer programs that may be executed by at least one processor 301. The one or more computer programs are executed by at least one processor 301 so that at least one processor 301 is capable of executing the production scheduling method described above.

An embodiment of the present disclosure further provides a computer-readable storage medium. The computer-readable storage medium stores a computer program therein, wherein the computer program, when being executed by a processor, implements the above-mentioned production scheduling method. The computer-readable storage medium may be a volatile or non-volatile computer-readable storage medium.

An embodiment of the present disclosure further provides a computer program product. The computer program product includes a computer-readable code or a non-volatile computer-readable storage medium carrying a computer-readable code. When the computer-readable code is operated in a processor of the electronic device, the processor in the electronic device performs the production scheduling method.

A person of ordinary skill in the art may understand that functional modules/units in all or some of the steps, system and apparatuses in the disclosed method may be implemented as software, firmware, hardware and their appropriate combinations. In the hardware implementation, the division between functional modules/units mentioned in the above description does not necessarily correspond to the division of physical components. For example, one physical component may have a plurality of functions, or one function or step may be executed by several physical components in cooperation. Some physical components or all physical components can be implemented as software executed by a processor, such as a central processing unit, a digital signal processor, or a microprocessor, or as hardware, or as an integrated circuit, such as an application specific integrated circuit. Such software may be distributed on the computer-readable storage medium, which may include a computer storage medium (or non-transient medium) and a communication medium (or transient medium).

As is well known to those of ordinary skill in the art, the term “computer storage medium” includes volatile and nonvolatile, removable and non-removable mediums implemented by any method or technology for storing the information, such as, computer readable instructions, data structures, program modules or other data. The computer storage medium includes, but is not limited to a random access memory (RAM), a read-only memory (ROM), an erasable programmable read-only memory (EPROM), a static random access memory (SRAM), a flash memory or other memory techniques, a compact disc read-only memory (CD-ROM), a digital video disk (DVD) or other optical storage, a tape cartridge, a magnetic tape, a disk storage or other magnetic storage devices, or any other medium that may be configured to store desired information and may be accessed by a computer. In addition, as is well known to those of ordinary skill in the art, communication media usually contain computer-readable instructions, data structures, program modules, or other data in a modulated data signal such as a carrier wave or other transmission mechanism, and may include any information delivery medium.

The computer-readable program instruction described here may be downloaded from a computer-readable storage medium to the corresponding computing/processing device or downloaded to an external computer or external storage device via a network, e.g., the Internet, local area network, wide area network and/or wireless network. The network may include a copper transmission cable, fiber optic transmission, wireless transmission, a router, a firewall, a switch, a gateway computer and/or an edge server. A network adapter card or network interface in each computing/processing device receives a computer-readable program instruction from a network and forwards the computer-readable program instruction for storage in a computer-readable storage medium in each computing/processing device.

Computer program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may be executed entirely on a user computer, partly on a user computer, as a stand-alone software package, partly on the user computer and partly on a remote computer, or entirely on a remote computer or a server. In a case of the remote computer, the remote computer may be connected to the user computer through any type of network (including a local area network (LAN) or wide area network (WAN)), or may be connected to an external computer (e.g., using an Internet service provider via the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the customized electronic circuitry, in order to perform aspects of the present disclosure.

The computer program product described here may be implemented in hardware, software, or any combination thereof. In an optional embodiment, the computer program product is specifically embodied as a computer storage medium. In another optional embodiment, a computer program product is specifically embodied as a software product, such as a software development kit (SDK), and so on.

Various aspects of the present disclosure are described here with reference to flowcharts and/or block diagrams of the method, the apparatus (system) and the computer program product according to embodiments of the present disclosure. It should be understood that each block of a flowchart and/or block diagram, and a combination of blocks in a flowchart and/or block diagram, may be implemented by the computer-readable program instructions.

These computer program instructions may be provided to a generate-purpose computer, a special-purpose computer or processors of other programmable data processing apparatuses, to create a machine, such that an apparatus for realizing functions/actions designated in one or more blocks in the flowchart and/or block diagrams, may be created by instructions performed by a computer or processors of other programmable data processing apparatuses. These computer-readable program instructions may also be stored in a computer-readable storage medium and enable the computer, the programmable data processing apparatus and/or other devices to work in a particular way. Therefore, a computer-readable medium on which instructions are stored includes a manufactured product that includes instructions that implement various aspects of the functions/actions specified in one or more of the blocks in the flowcharts and/or block diagrams.

These computer-readable program instructions may further be loaded into a computer, other programmable data processing apparatuses or other devices, such that a series of operating steps may be performed on the computer, other programmable data processing apparatuses or other devices, so as to generate processes realized by the computer, such that the functions/actions designated in one or more blocks in the flowcharts and/or in one or more blocks in the block diagrams may be implemented by the instructions executed on the computer, other programmable data processing apparatuses or other devices.

The flowchart and block diagram in the accompanying drawings illustrate the system architecture, functions and operations of the system, method and computer program product that may be implemented in accordance with a plurality of embodiments of the present disclosure. At this point, each block in the flowchart or block diagram may represent a module, a program segment, or part of codes, wherein the module, program segment, or part of codes contains one or more executable instructions for implementing a specified logical function. In some alternative implementations, the functions indicated in the blocks may also occur in a different order than those indicated in the drawings. For example, two blocks represented consecutively may actually be performed in substantially parallel, and they may sometimes be performed in a reverse order, depending on the functionality involved. It should also be noted that each block in the block diagram and/or flowchart, and the combination of blocks in the block diagram and/or flowchart, may be implemented by a dedicated hardware-based system for performing a specified function or action, or may be implemented by a combination of dedicated hardware and computer instructions.

Exemplary embodiments have been disclosed herein. In addition, while specific terms are employed, they are used and should be construed only for a general illustrative meaning and not for the purpose of limitation. In some cases, it is obvious to those skilled in the art that, unless otherwise expressly indicated, the features, characteristics and/or elements described in combination with a particular embodiment may be used alone or in combination with other embodiments. Therefore, those skilled in the art will understand that various changes in form and detail may be made without departing from the scope of the present disclosure as illustrated by the accompanying claims.

1. A production scheduling method for a flexible job shop, comprising:
generating an initialized population according to information on to-be-produced workpieces, wherein the population comprises a plurality of production scheduling schemes, and each of the plurality of production scheduling schemes represents a production scheduling sequence of the to-be-produced workpieces; and
performing iterative updating on the population based on a preset target iterative algorithm, and determining a target production scheduling scheme according to an iteration process.

2. The production scheduling method according to claim 1, wherein before performing the iterative updating on the population based on the preset target iterative algorithm, the method further comprises: acquiring an adaptive value corresponding to the production scheduling scheme for each of the plurality of production scheduling schemes in the population, wherein the adaptive value represents a production makespan corresponding to the production scheduling scheme; and
the performing the iterative updating on the population based on the preset target iterative algorithm and determining the target production scheduling scheme according to the iteration process comprises:
performing iterative updating on the population according to the adaptive value based on the preset target iterative algorithm; and
determining the target production scheduling scheme according to an optimal solution obtained in the iteration process.

3. The production scheduling method according to claim 2, after each iterative updating, the method further comprises:
determining whether a current iteration round exceeds an iteration round threshold;
returning a step of acquiring the adaptive value corresponding to the production scheduling scheme for each of the plurality of production scheduling schemes in the population, in response to the current iteration round not exceeding the iteration round threshold; and
jumping to executing a step of determining the target production scheduling scheme based on the optimal solution obtained in the iteration process, in response to the current iteration round exceeding the iteration round threshold.

4. The production scheduling method according to claim 2, wherein the target iterative algorithm comprises a first particle swarm algorithm; the workpiece information comprises types of to-be-produced workpieces, a number of each type of workpieces, a total number of processes of each type of workpieces, a number of stage processes corresponding to each production stage, and a batch size of batch production; and the generating the initialized population according to the information on the to-be-produced workpieces comprises:
determining type codes of each type of workpieces according to a ratio of the number of each type of workpieces to the batch size, in order to obtain a type code sequence;
performing code extension on each type code in the type code sequence according to the number of production stages of each type of workpieces to obtain a first extended code sequence, wherein each element in the first extended code sequence represents a corresponding workpiece type and a corresponding production stage, and the number of production stages is a ratio of the total number of processes to the number of stage processes;
adjusting sequence of elements in the first extended code sequence, and generating a plurality of second extended code sequences having different sequences of elements, wherein each population particle corresponds to one second extended code sequence;
generating a weight code sequence and a velocity list which correspond to the population particle for each population particle in the population, wherein the weight code sequence comprises weight codes that are in one-to-one correspondence to elements corresponding to the second extended code sequence, and the velocity list comprises velocities that are in one-to-one correspondence to the elements corresponding to the second extended code sequence; and
performing code extension on each element in the second extended code sequence corresponding to the population particle according to the number of each type of workpieces and the number of stage processes to obtain a third extended code sequence corresponding to the population particle, wherein each element in the third extended code sequence represents a workpiece number of one workpiece and a stage process in the corresponding production stage, and the third extended code sequence represents one production scheduling scheme.

5. The production scheduling method according to claim 4, wherein the performing the iterative updating on the population according to the adaptive value based on the target iterative algorithm comprises:
determining a current global optimal solution of the population according to an adaptive value corresponding to each population particle, wherein the current global optimal solution of the population is a current global optimal population particle;
for each population particle, updating a weight code sequence corresponding to the population particle according to a weight code sequence corresponding to the current global optimal solution of the population and the weight code sequence corresponding to the population particle;
adjusting a sequence of corresponding elements in the second extended code sequence corresponding to the population particle according to the updated weight code sequence corresponding to the population particle; and
adjusting a sequence of corresponding elements in the third extended code sequence corresponding to the population particle according to adjusted second extended code sequence corresponding to the population particle to update a corresponding production scheduling scheme.

6. The production scheduling method according to claim 2, wherein the target iterative algorithm comprises a genetic algorithm; the workpiece information comprises types of to-be-produced workpieces, a number of each type of workpieces, and a batch size of batch production; and the generating the initialized population according to the information on the to-be-produced workpieces comprises:
performing chromosome coding according to the types of to-be-produced workpieces to obtain a plurality of type chromosome coding sequences; and
decoding each type chromosome coding sequence according to the number of each type of workpieces to obtain an individual chromosome decoding sequence corresponding to each type chromosome coding sequence, wherein each element in the individual chromosome decoding sequence represents a workpiece number of each workpiece corresponding to the workpiece type, and each individual chromosome decoding sequence represents one production scheduling scheme.

7. The production scheduling method according to claim 6, wherein the performing the iterative updating on the population according to the adaptive value based on the target iterative algorithm comprises:
regenerating the individual chromosome decoding sequence into a corresponding type chromosome coding sequence according to a reverse order of decoding, for each individual chromosome decoding sequence in the population;
performing a genetic operation on the type chromosome coding sequence in the population based on an adaptive value corresponding to each of the plurality of type chromosome coding sequences in the population, so as to update the type chromosome coding sequence in the population; and
decoding each updated type chromosome coding sequence in the population to obtain an individual chromosome decoding sequence corresponding to the each updated type chromosome coding sequence.

8. The production scheduling method according to claim 2, wherein the target iterative algorithm comprises a second particle swarm algorithm; the workpiece information comprises a number of to-be-produced workpieces, and a number of processes of each workpiece;
and the generating the initialized population according to the information on the to-be-produced workpieces comprises:
generating a plurality of production scheduling schemes according to the number of to-be-produced workpieces and the number of process of each workpiece, wherein each production scheduling scheme corresponds to one population particle; and
randomly initializing inertia weight, position and velocity parameters corresponding to each population particle.

9. The production scheduling method according to claim 8, wherein the performing the iterative updating on the population according to the adaptive value based on the target iterative algorithm comprises:
dividing a plurality of population particles in the population into a plurality of groups of population particles according to a corresponding sequence of adaptive values from small to large, wherein each group of population particles comprises a master population particle and at least one slave population particle;
determining an in-group optimal solution of each group of population particles according to a corresponding adaptive value of each population particle in each group of population particles, wherein the in-group optimal solution is a population particle corresponding to a minimum value among adaptive values of all population particles in the group, and a position of the master population particle is a position of a population particle corresponding to the in-group optimal solution;
determining a current global optimal solution of the population according to an adaptive value corresponding to the in-group optimal solution of each group of population particles, wherein the current global optimal solution is an in-group optimal solution corresponding to a minimum adaptive value; and
updating a position and velocity of each population particle in each group of population particles according to the in-group optimal solution and the current global optimal solution of the population, for each group of population particles.

10. The production scheduling method according to claim 9, wherein after the performing the iterative updating on the population according to the adaptive value based on the target iterative algorithm, the method further comprises:
determining inert population particles in the population according to a historical velocity and a historical position of each population particle in the population; and
eliminating the inert population particles from the population, and adding a corresponding number of new population particles to the population.

11. The production scheduling method according to claim 10, wherein the determining the inert population particles in the population according to the historical velocity and the historical position of each population particle in the population comprises:
determining the population particles to be the inert population particles in response to a variation in a plurality of historical velocities of the population particles being less than a first threshold, and a variation in a plurality of historical positions of the population particles being less than a second threshold.

12. A production scheduling apparatus for a flexible job shop, comprising:
an initializing unit, configured to generate an initialized population according to information on to-be-produced workpieces, wherein the population comprises a plurality of production scheduling schemes, and each of the plurality of production scheduling schemes represents a production scheduling sequence of the to-be-produced workpieces; and
an updating iteration unit, configured to perform iterative updating on the population based on a preset target iterative algorithm, and determine a target production scheduling scheme according to an iteration process.

13. The production scheduling apparatus according to claim 12, further comprising an acquiring unit, wherein
the acquiring unit is configured to acquire an adaptive value corresponding to the production scheduling scheme for each of the plurality of production scheduling schemes in the population, wherein the adaptive value represents a production makespan corresponding to the production scheduling scheme; and
the updating interaction unit comprises:
an updating sub-unit, configured to perform iterative updating on the population according to the adaptive value based on the preset target iterative algorithm; and
a target determining sub-unit, configured to determine the target production scheduling scheme according to an optimal solution obtained in the iteration process.

14. An electronic device, comprising:
at least one processor; and
a memory being in communication connection with the at least one processor, wherein
the memory is configured to store one or more computer programs that can be executed by the at least one processor, the one or more computer programs, when being executed by the at least one processor, cause the at least one processor to implement the production scheduling method according to claim 1.

15. A computer-readable storage medium, configured to store a computer program therein, wherein the computer program, when being executed by a processor, implements the production scheduling method according to claim 1.
